(19) United States
(12) Patent Application Publication
(10) Pub. No.: US 2025/0278912 A1
(43) Pub. Date: Sep. 4, 2025

(54) PET RECONSTRUCTION SYSTEM BASED ON A VIRTUAL WORLD INFRASTRUCTURE AND METHOD FOR IMPLEMENTING THEREOF

(71) Applicant: ETERNAL METAVERSE JOURNEY PETS LIFE MEMORIAL CO., LTD., Taipei City (TW)

(72) Inventor: Jing Yu Yu, Taipei City (TW)

(21) Appl. No.: 19/068,390

(22) Filed: Mar. 3, 2025

(30) Foreign Application Priority Data
Mar. 1, 2024 (TW) 113107626

(51) Int. Cl. G06T 19/20; G06T 13/40

(52) U.S. Cl. CPC G06T 19/20; G06T 13/40; G06T 2219/2008

(57) ABSTRACT

The present disclosure relates to a pet reconstruction system based on a virtual world infrastructure and its implementation method. The system primarily comprises a server and one or more terminal devices. The server is in data communication with a model database, a customization database, a data processing module, a virtual pet generation module, an environment generation module, and a real-time analysis module. By analyzing the features of a particular animal and comparing them with models stored in the model database, a virtual identity corresponding to the particular animal is generated. Finally, the real-time analysis module receives at least one command, enabling the virtual identity to execute its model based on the received command. This allows real-time adjustment of the virtual pet's behavior, thereby recreating the emotional connection between the pet owner and the pet in a virtual environment.

### BACKGROUND OF INVENTION

### (1) Field of the Present Disclosure

The present disclosure relates to a pet reconstruction system based on a virtual world infrastructure and a method for implementing thereof.

### (2) Brief Description of Related Art

In the past, when a pet passed away, pet owners could only recall the time spent with their pets through videos and photos, which failed to offer an interactive experience. Traditional ways of remembering pets were limited to static visual and auditory elements, lacking dynamic, emotionally resonant interactions. Under such circumstances, pet owners may struggle to relive authentic moments with their pets. Moreover, this lack of interactivity in the remembrance process can create a sense of distance and helplessness for pet owners when reminiscing about their pets.

Chinese Patent Publication No. CN114870404A discloses a virtual pet generation method, apparatus, electronic device, and storage medium. The method includes obtaining multiple pet images captured from various angles by a user. Each pet image corresponds to a specific shooting angle. The method extracts features from the images to obtain characteristics of the pet's body parts. Based on these features, the method determines the virtual pet's appearance. Additionally, the method determines voice parameters for the virtual pet based on the user's characteristics. These voice parameters are used during interactions between the virtual pet and the user. Finally, the virtual pet is generated according to the appearance image and the voice parameters.

However, conventional virtual pet systems still lack precise control over specific behaviors and actions in different scenarios, such as the unique personality traits, habits, and movements of individual pets. In these systems, the behaviors of virtual pets are significantly limited, making it difficult to realistically simulate the rich variety of actions and reactions that pets might display in various environments. Therefore, a need exists to develop a virtual pet system that enables realistic interactions in diverse scenarios. Such a system would allow virtual pets to engage more authentically with users, the environment, and other virtual objects. It would provide pet owners with a way to recreate interactions with their pets in a virtual environment, enabling them to directly and dynamically interact with their deceased pets and cherish their memories in the virtual world.

### SUMMARY OF INVENTION

It is a primary object of the present disclosure to provide to provide a pet reconstruction system and a method for reconstructing a pet in a virtual world infrastructure. This system allows a lifelike virtual pet to reappear before its owner and engage in interactive experiences, fulfilling the user's need for realistic interactions with a customized virtual pet and recreating the emotional connection between the owner and the pet in a virtual environment.

According to the present disclosure, a virtual world infrastructure comprises a server and one or more terminal devices. The server is in data communication with a model database, a customization database, a data processing module, a virtual pet generation module, an environment generation module, and a real-time analysis module. The model database stores multiple 3D appearance models, behavior models, and voice models for various animal species. The customization database stores the specific appearance features, specific behavior features, and specific voice features of a particular animal. The data processing module analyzes the specific features of the particular animal and compares them with the multiple models stored in the model database to generate a specific 3D appearance model, a specific behavior model, and a specific voice model for the particular animal, which are stored in the customization database. The virtual pet generation module creates a virtual identity for the particular animal based on its specific 3D appearance model, specific behavior model, and specific voice model to complete the reconstruction. The environment generation module creates a virtual environment and sends at least one environmental command to the real-time analysis module. The real-time analysis module receives at least one user command from one or more terminal devices and/or at least one environmental command from the environment generation module. Based on these commands, the virtual identity executes any one or a combination of its specific 3D appearance model, specific behavior model, and specific voice model. The terminal devices are in data communication with the server to download the virtual identity, including the specific 3D appearance model, specific behavior model, and specific voice model of the particular animal. This allows the virtual pet's behavior to be adjusted in real time, enabling it to exhibit more realistic responses in various environments. Consequently, the system satisfies the user's need for realistic interaction with a customized virtual pet and recreates the emotional connection between the owner and the pet in the virtual environment.

### BRIEF DESCRIPTION OF THE DRAWINGS

FIG. 1 is a block diagram illustrating the system architecture of the present disclosure;

FIG. 2 is the system architecture of the present disclosure;

FIG. 3 is a flow chart I of the present disclosure;

FIG. 4 is a flow chart II of the present disclosure;

FIG. 5 is a scenario diagram I of the present disclosure;

FIG. 6 is a flow chart III of the present disclosure;

FIG. 7 is a scenario diagram II of the present disclosure;

FIG. 8 is a flow chart IV of the present disclosure;

FIG. 9 is a scenario diagram III of the present disclosure;

FIG. 10 is a flow chart V of the present disclosure; and

FIG. 11 is a scenario diagram IV of the present disclosure.

### DETAILED DESCRIPTION OF PREFERRED EMBODIMENTS

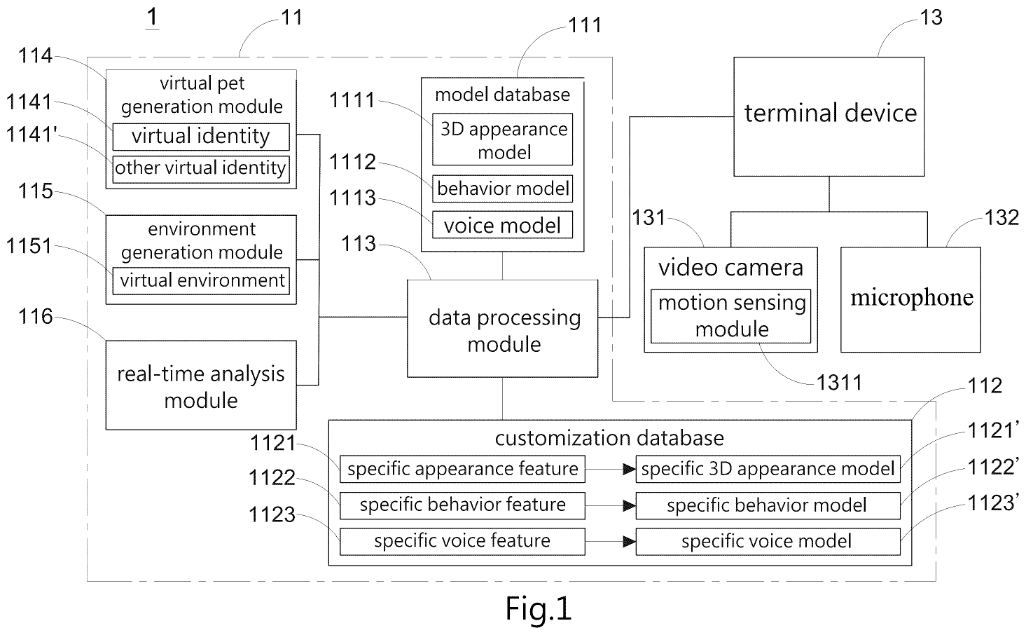

Referring to FIG. 1, the pet reconstruction system 1 of the present disclosure is based on a virtual world infrastructure and is composed of a server 11 and one or more terminal devices 13. The server 11 is in data communication with a model database 111, a customization database 112, a data processing module 113, a virtual pet generation module 114, an environment generation module 115, and a real-time analysis module 116. The model database 111 is used to store multiple 3D appearance models 1111, multiple behavior models 1112, and multiple voice models 1113 for various animal species. The customization database 112 is used to store specific appearance features 1121, specific behavior features 1122, and specific voice features 1123 of a particular animal. The data processing module 113 analyzes the specific appearance features 1121, specific behavior features 1122, and specific voice features 1123 of the specific animal and compares them with the multiple 3D appearance models 1111, behavior models 1112, and voice models 1113 stored in the model database 111. Based on the comparison results, the data processing module 113 generates a specific 3D appearance model 1121′, a specific behavior model 1122′, and a specific voice model 1123′ for the specific animal, which are then stored in the customization database 112. The virtual pet generation module 114 generates a virtual identity 1141 for the specific animal based on the specific 3D appearance model 1121′, the specific behavior model 1122′, and the specific voice model 1123′, thereby completing the reconstruction. The environment generation module 115 generates a virtual environment 1151 and sends at least one environmental command to the real-time analysis module 116. The real-time analysis module 116 receives at least one user command from one or more terminal devices 13 and/or at least one environmental command from the environment generation module 115, causing the virtual identity 1141 to execute any one or a combination of the specific 3D appearance model 1121′, the specific behavior model 1122′, and the specific voice model 1123′ according to the received command. Additionally, the real-time analysis module 116 may further enable the virtual identity 1141 to send and/or receive at least one virtual pet command from at least one other virtual identity 1141′ in the virtual environment 1151, causing the virtual identity 1141 to execute any one or a combination of the specific 3D appearance model 1121′, the specific behavior model 1122′, and the specific voice model 1123′ according to the virtual pet command. Moreover, one or more terminal devices 13 are in data-communication with the server 11 for downloading the virtual identity 1141, which includes the specific 3D appearance model 1121′, the specific behavior model 1122′, and the specific voice model 1123′ of the specific animal.

The 3D appearance models 1111 stored in the model database 111 and the specific 3D appearance models 1121′ stored in the customization database 112 may respectively include, but are not limited to, at least one or a combination of the following parameters: breed, gender, age, skin color, fur color, markings, body size, and physical structure. The behavior models 1112 and the specific behavior models 1122′ may include at least one or a combination of the following parameters: sleep, foraging, communication, entertainment, learning, attack, defense, or other habits or actions. The voice models 1113 and the specific voice models 1123′ may respectively include, but are not limited to, at least one or a combination of the following parameters: pitch, frequency, volume, rhythm, continuity, and voice type.

The terminal device 13 may include a video camera 131 and a microphone 132. The video camera 131 is used to capture real-time image data from the real world and transmit it to the server 11. The microphone 132 is used to capture real-time audio data from the real world and transmit it to the server 11. Additionally, the video camera 131 may be equipped with a motion sensing module 1311 for capturing motion data of at least one object within the real-time image data and transmitting it to the server 11.

In the present disclosure, the real-time analysis module 116 may further adjust various parameters in the specific 3D appearance model 1121′, the specific behavior model 1122′, and the specific voice model 1123′ of the virtual identity 1141 based on environmental commands from the virtual environment 1151. Additionally, the real-time analysis module 116 can adjust various parameters in the specific 3D appearance model 1121′, the specific behavior model 1122′, and the specific voice model 1123′ of the virtual identity 1141 based on real-time image data transmitted from the video camera 131 to the server 11, real-time audio data transmitted from the microphone 132 to the server 11, and/or motion data transmitted from the motion sensing module 1311 to the server 11.

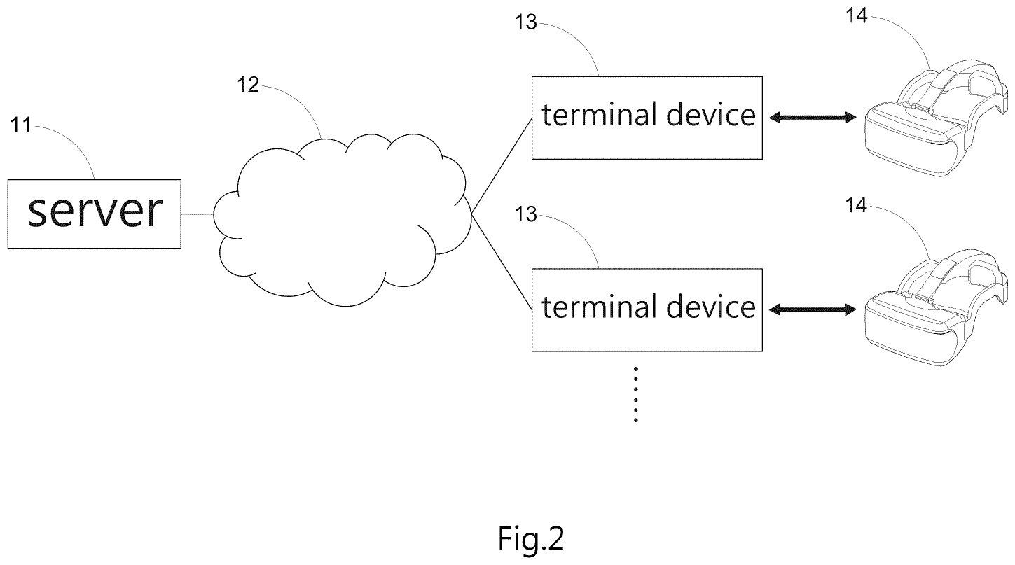

Referring to FIG. 2, the server 11 can be in data communication with one or more terminal devices 13 via an Internet network 12. Through the Internet 12, users of the terminal devices 13 can download necessary data from the server 11 or upload required data to the server 11. The Internet 12 may be a wide-area network, a 4G network, a 5G network, a Wi-Fi network, or a combination thereof. The terminal device 13 may be a mobile phone, a tablet computer, or a personal computer, among other devices capable of connecting to the server 11 via the network. Additionally, the terminal device 13 can be used in conjunction with a virtual reality display device 14, which may be a glasses-type or head-mounted virtual reality display device for presenting any virtual object information downloaded to the terminal device 13.

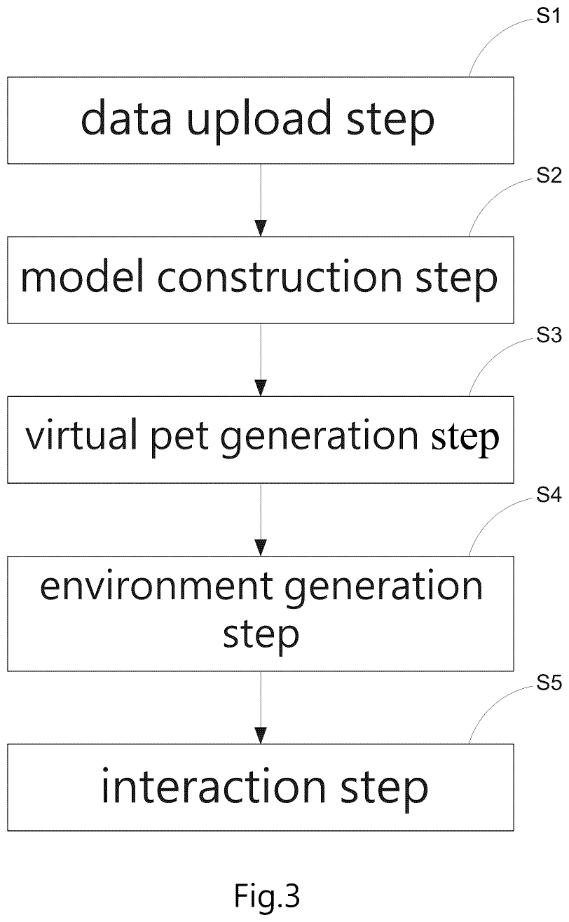

Referring to FIG. 3, the method of implementation of the present disclosure includes the following steps:

1. Data Upload Step S1: The specific appearance features 1121, specific behavior features 1122, and specific voice features 1123 of a specific animal are uploaded to the customization database 112 of the server 11.

2. Model Construction Step S2: The data processing module 113 analyzes the specific appearance features 1121, specific behavior features 1122, and specific voice features 1123 of the specific animal to generate the specific 3D appearance model 1121′, specific behavior model 1122′, and specific voice model 1123′, which are then stored in the customization database 112.

3. Virtual Pet Generation Step S3: The virtual pet generation module 114 generates a virtual identity 1141 for the specific animal based on its specific 3D appearance model 1121′, specific behavior model 1122′, and specific voice model 1123′, thereby completing the reconstruction.

4. Environment Generation Step S4: The environment generation module 115 generates a virtual environment 1151.

5. Interaction Step S5: The real-time analysis module 116 receives at least one user command from the terminal device 13 and/or at least one environmental command from the environment generation module 115, causing the virtual identity 1141 to execute any one or a combination of the specific 3D appearance model 1121′, specific behavior model 1122′, and specific voice model 1123′. Additionally, the real-time analysis module 116 may enable the virtual identity 1141 to send and/or receive at least one virtual pet command from at least one other virtual identity 1141′ in the virtual environment 1151. Based on the virtual pet command, the virtual identity 1141 adjusts the parameters in the specific 3D appearance model 1121′, specific behavior model 1122′, and specific voice model 1123′ to perform corresponding actions.

The “upload” described in the Data Upload S1 step may be implemented through various means. For example, a software application can be provided, allowing users to execute the application on the terminal device 13 and input the specific appearance features 1121, specific behavior features 1122, and specific voice features 1123 of the specific animal. These features can then be uploaded to the customization database 112 of the server 11 via the Internet 12. Alternatively, a web interface can be provided, enabling users to input the aforementioned features through a web browser and upload them to the customization database 112 of the server 11 via the Internet 12. Furthermore, both the software application and the web interface may be equipped with an application programming interface API, allowing developers to write API requests using programming languages such as Python or Java. These API requests can upload the specified features in a particular format such as JSON or XML to the customization database 112 of the server 11. In another example, the data containing the specified features may be stored on a conventional external storage device, such as a solid-state drive SSD or a hard disk drive HDD. The external storage device can then be directly connected to the physical equipment where the server 11 is located, enabling direct upload of the specified features to the customization database 112.

Additionally, in the Data Upload S1 step, an animal wearable device may be further provided, which may include but is not limited to an image sensor, such as a video camera, for capturing the specific appearance features 1121 of the specific animal; a behavior sensor, such as an accelerometer or gyroscope, for capturing the specific behavior features 1122 of the specific animal; and an audio sensor, such as a microphone, for capturing the specific voice features 1123 of the specific animal. The collected data can then be uploaded to the customization database 112 of the server 11 via the Internet 12.

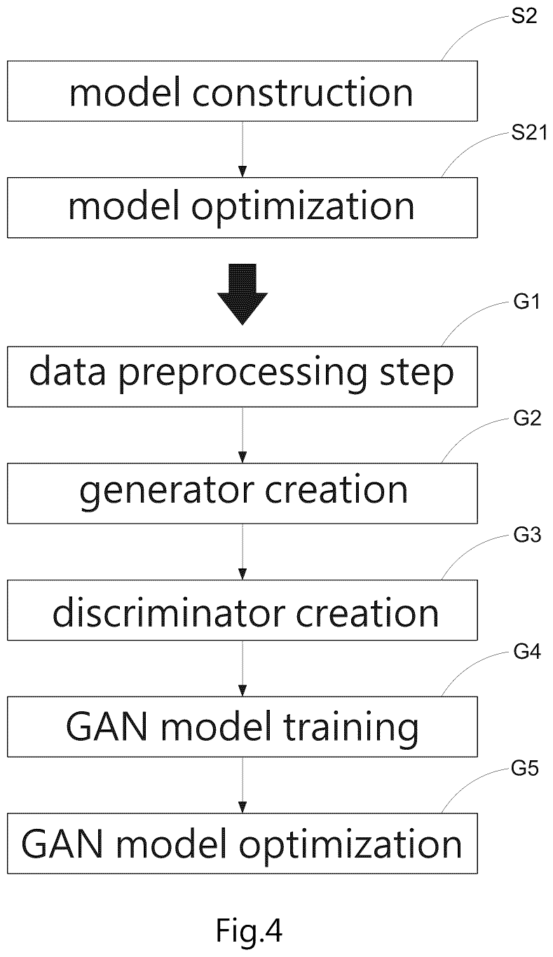

Referring to FIG. 4, the Model Construction S2 step may further include a “Model Optimization S21” step. In this step, the data processing module 113 first compares the specific appearance features 1121, specific behavior features 1122, and specific voice features 1123 of the specific animal with multiple 3D appearance models 1111, behavior models 1112, and voice models 1113 of different animal species stored in the model database 111. After the comparison, the data processing module 113 generates the specific 3D appearance model 1121′, specific behavior model 1122′, and specific voice model 1123′ for the specific animal, thereby further improving the completeness and accuracy of these models.

Additionally, the Model Optimization S21 step may utilize deep learning to achieve model optimization. For example, a generative adversarial network GAN can be employed, which includes the following steps:

1. Data Preprocessing G1 Step: This step involves preprocessing the specific appearance features 1121, specific behavior features 1122, and specific voice features 1123 collected in the Data Upload S1 step, as well as other supplementary data e.g., text descriptions of the pet's behavior provided by the owner. Additionally, the multiple 3D appearance models 1111, behavior models 1112, and voice models 1113 stored in the model database 111 undergo data cleaning, normalization, and preprocessing to ensure data consistency. The processed data serves as real animal data.

2. Generator Creation G2 Step: A generator model is created to accept a random noise vector as input and output a predicted result for the species of the specific animal. For example, when the generator produces canine features based on a random noise vector, slightly unnatural predictions may appear in the generated output, such as irregularities in fur texture, color variations, or the shape of certain body parts.

3. Discriminator Creation G3 Step: A discriminator model is created to distinguish between real animal data and generated predictions. It identifies whether the input data is real animal data or generated predictions.

4. GAN Model Training G4 Step: The discriminator is trained using both real animal data and predictions generated by the generator. The discriminator learns to distinguish real animal data from generated predictions, while the generator is trained to deceive the discriminator such that the predictions become increasingly realistic.

5. GAN Model Optimization G5 Step: This step involves multiple iterations of training the GAN model in step G4. The generator and discriminator weights are adjusted as needed to optimize the performance of the GAN model.

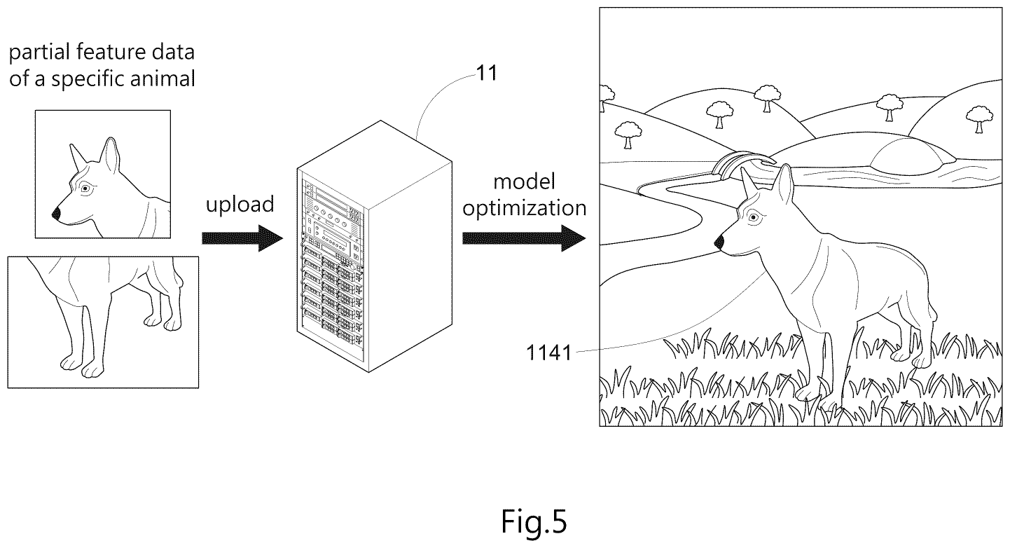

Referring to FIG. 5, when the provided specific features of the specific animal are incomplete, meaning that only partial feature data is uploaded, the comparison process in the Model Optimization S21 step allows the data processing module 113 of the server 11 to search for available similar models in the model database 111 to supplement the missing specific features of the particular animal. Specifically, for example, if the provided feature data lacks the complete facial appearance, torso, limbs, voice, or inherent habits of the particular animal, the data processing module 113 can infer the missing features through the comparison process and use data from similar individuals of the same or related species in the model database 111 to further improve the completeness and accuracy of the model. This ensures that even when the specific feature data of the specific animal is insufficient, a more realistic virtual identity 1141 can still be established, providing users with a more comprehensive and lifelike experience.

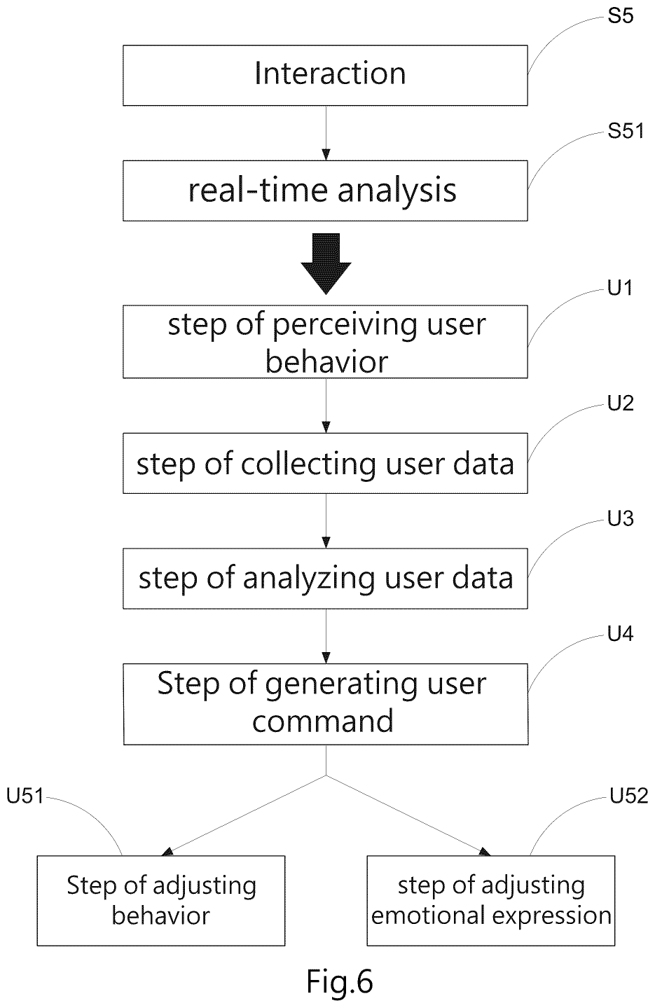

Referring to FIG. 6, in the Interaction S5 step, a “Real-Time Analysis S51” step may be further included. In this step, the real-time analysis module 116 adjusts various parameters in the specific 3D appearance model 1121′, specific behavior model 1122′, and specific voice model 1123′ of the virtual identity 1141 based on real-time image data transmitted from the video camera 131 to the server 11, real-time audio data transmitted from the microphone 132 to the server 11, and/or motion data transmitted from the motion sensing module 1311 to the server 11. This adjustment enables the virtual identity 1141 to interact more closely with the user's behavior, providing the user with a more dynamic, personalized, and realistic experience.

Additionally, in the Real-Time Analysis S51 step, the following steps may be further included following steps:

1. Step U1 of perceiving user behavior: The video camera 131, microphone 132, and/or motion sensing module 1311 detect the user's behavior, which may include a movement, a gesture, and/or a voice, either individually or in combination. The detected data is then transmitted to the server 11.

2. Step U2 of collecting user data: The real-time analysis module 116 collects user-related data in the virtual environment 1151, such as real-time user image data, real-time user audio data, and/or user motion data corresponding to the detected behavior.

3. Step U3 of analyzing user data: The real-time analysis module 116 performs emotional analysis on the collected user data to understand the user's intention and commands. For example, by using deep learning with a generative adversarial network GAN, the system can be trained with a large dataset containing emotional labels-such as positive, negative, or neutral emotions-based on facial expressions, voice intonation, or body gestures. This allows the real-time analysis module 116 to predict the emotional category associated with specific user actions or speech.

Step U4 of generating user command: Based on the emotional analysis results, the real-time analysis module 116 generates a corresponding user command for the virtual identity 1141.

Step U51 of adjusting behavior: When the virtual identity 1141 receives the user command based on the emotional analysis results, it adjusts various parameters in its specific 3D appearance model 1121′, specific behavior model 1122′, and specific voice model 1123′ to perform corresponding actions such as sleeping, foraging, or communicating. Alternatively, in the step U52 of adjusting emotional expression, the virtual identity 1141 adjusts various parameters in its specific 3D appearance model 1121′, specific behavior model 1122′, and specific voice model 1123′ to express corresponding emotions, such as excitement, fear, or happiness.

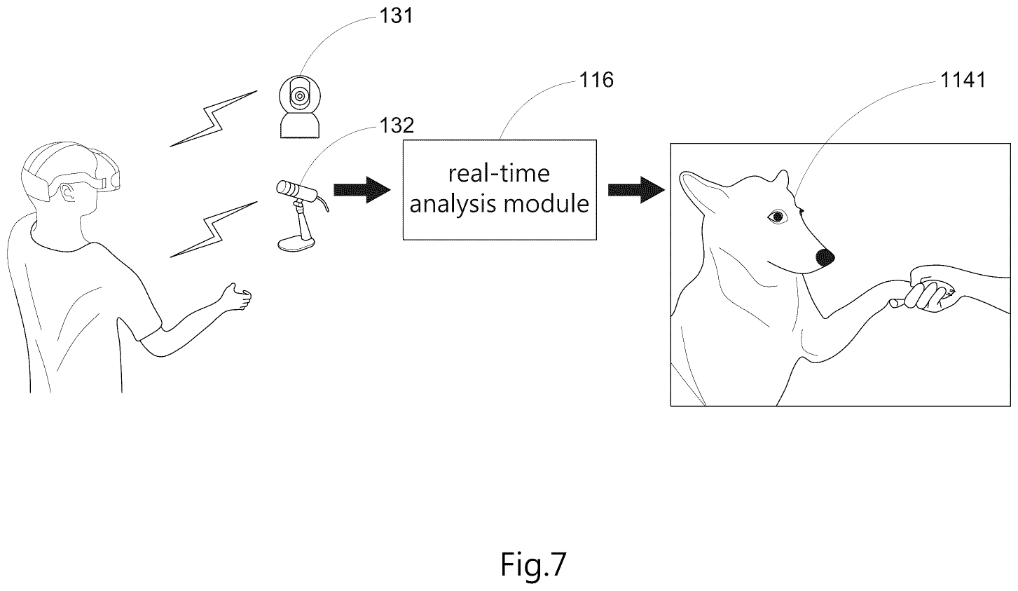

Referring to FIG. 7 in conjunction with FIG. 6, when the user performs a handshake gesture, the real-time analysis module 116 can detect and process the user's visual action through the video camera 131 by capturing the motion and position of the user's hand to determine that the user is performing a handshake gesture. Alternatively, the real-time analysis module 116 may receive an audio signal through the microphone 132 to detect other possible verbal commands, such as a spoken handshake instruction. Subsequently, through the previously described steps U1 to U52, the virtual identity 1141 performs the corresponding handshake action.

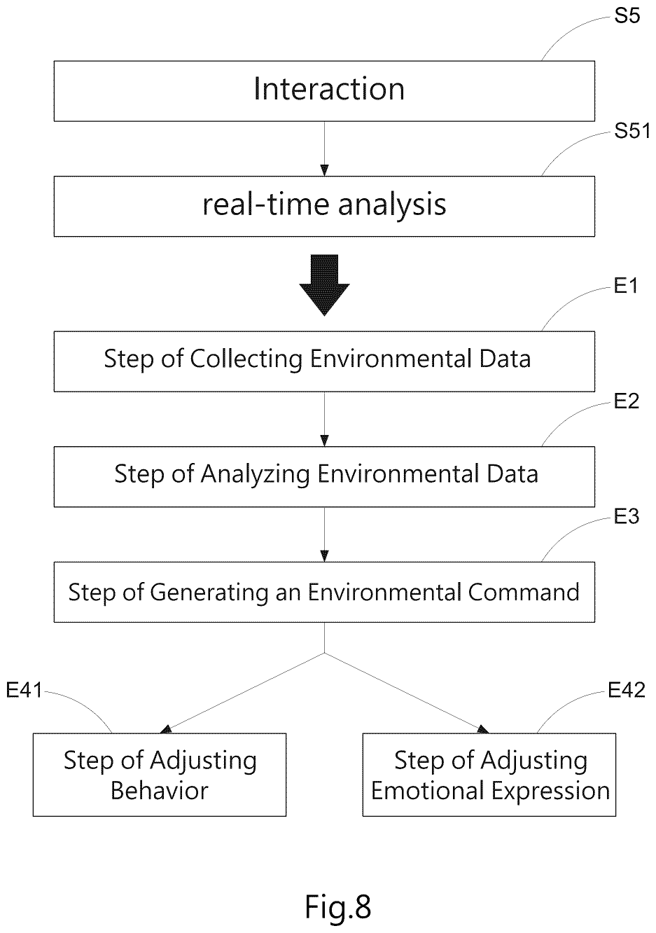

Referring to FIG. 8, in the Real-Time Analysis S51 step, the virtual identity 1141 may further adjust various parameters in the specific 3D appearance model 1121′, specific behavior model 1122′, and specific voice model 1123′ based on environmental commands from the virtual environment 1151, which includes the following steps:

Step E1 of Collecting Environmental Data: The real-time analysis module 116 collects environmental change data from the virtual environment 1151, including transitions between day and night, weather variations, lighting changes, and object movements.

Step E2 of Analyzing Environmental Data: The real-time analysis module 116 conducts an environmental analysis on the collected environmental change data to determine trigger conditions. For instance, by utilizing deep learning with a generative adversarial network GAN, the system can be trained on a large dataset of environmental parameters, such as the intensity of thunder or rain sounds, the brightness of sunlight or lightning, or the magnitude of ground vibrations. This enables the real-time analysis module 116 to identify the appropriate behavior or emotional response of the virtual identity 1141 under specific environmental conditions.

Step E3 of Generating an Environmental Command: Based on the results of the environmental analysis, the real-time analysis module 116 generates a corresponding environmental command for the virtual identity 1141.

Step E41 of Adjusting Behavior: Upon receiving the environmental command derived from the environmental analysis results, the virtual identity 1141 adjusts various parameters in its specific 3D appearance model 1121′, specific behavior model 1122′, and specific voice model 1123′ to execute corresponding actions, such as sleeping, foraging, or communicating. Alternatively, in the Step E42 of Adjusting Emotional Expression, the virtual identity 1141 modifies various parameters in its specific 3D appearance model 1121′, specific behavior model 1122′, and specific voice model 1123′ to express corresponding emotions, such as excitement, fear, or happiness.

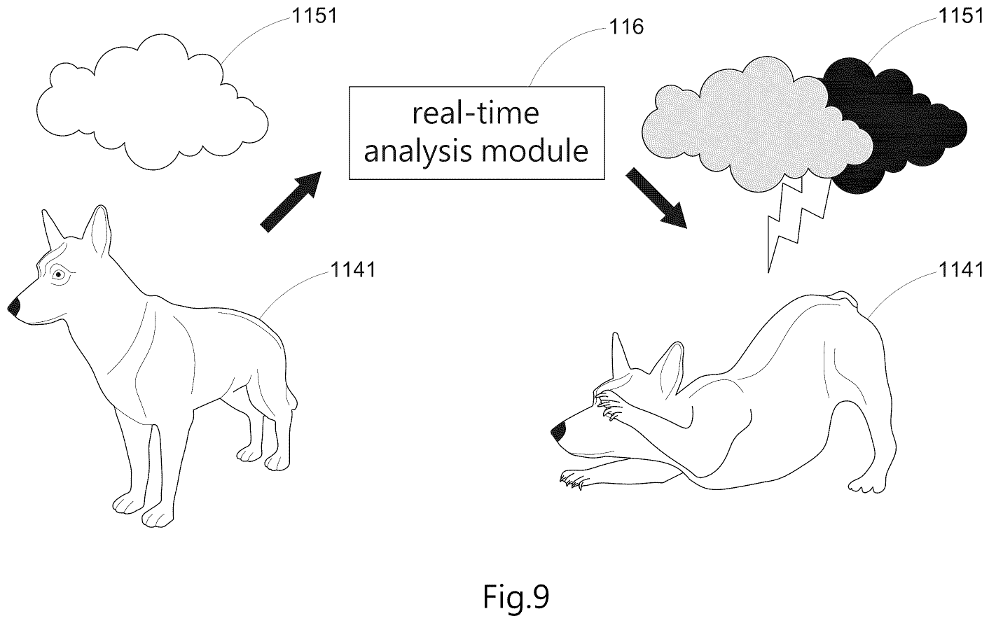

Referring to FIG. 9 in conjunction with FIG. 8, when the environment generation module 115 introduces weather effects in the virtual environment 1151, such as simulated dark clouds, lightning, and thunder sounds, the real-time analysis module 116 can, through the previously described steps E1 to E42, trigger a fear emotion in the virtual identity 1141. The virtual identity 1141 then performs a corresponding action by covering its eyes with its front paws.

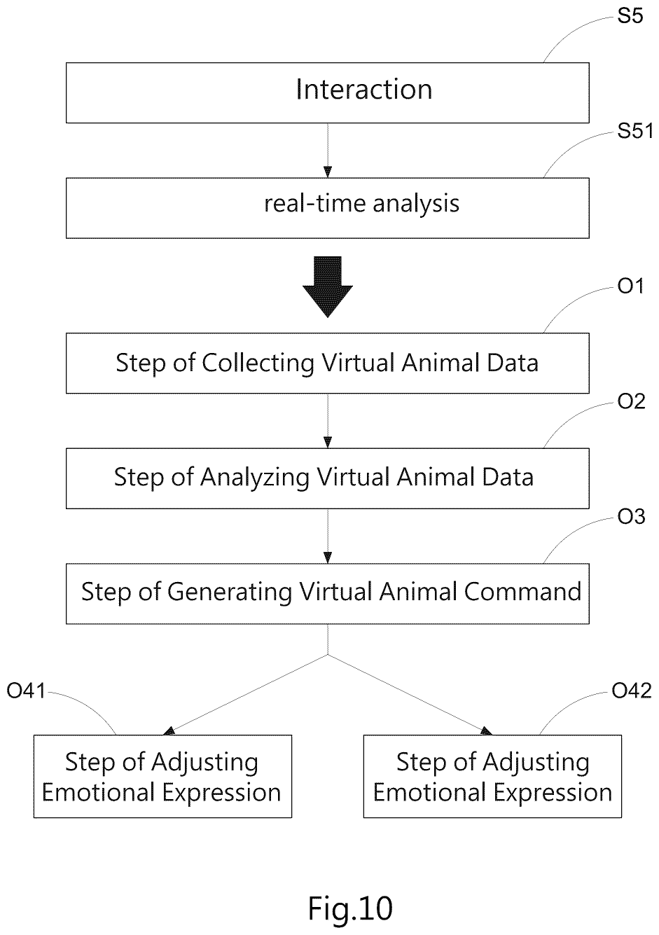

Referring to FIG. 10, in the Real-Time Analysis S51 step, various parameters in specific 3D appearance model 1121′, specific behavior model 1122′, and specific voice model 1123′ of the the virtual identity 1141 may be further adjusted based on the behavior and emotions of at least one other virtual identity 1141′ in the virtual environment 1151. This includes the following steps:

Step O1 of Collecting Virtual Animal Data: The real-time analysis module 116 collects behavioral and emotional data from other virtual identities 1141′ in the virtual environment 1151, including sound, motion, and position data.

Step O2 of Analyzing Virtual Animal Data: The real-time analysis module 116 performs a virtual animal analysis on the collected behavioral and emotional data of the other virtual identities 1141′ to determine trigger conditions. For example, by utilizing deep learning with a generative adversarial network GAN, the system can be trained on a large dataset containing animal interaction data, such as mutual sniffing, playing, or coordinated actions. This enables the real-time analysis module 116 to identify the specific behavior or emotional response that should be triggered in the virtual identity 1141 based on the behavior and emotions of the other virtual identities 1141′.

Step O3 of Generating a Virtual Animal Command: Based on the results of the virtual animal analysis, the real-time analysis module 116 generates a corresponding virtual animal command for the virtual identity 1141.

Step O41 of Adjusting Behavior: Upon receiving the virtual animal command derived from the virtual animal analysis results, the virtual identity 1141 adjusts various parameters in its specific 3D appearance model 1121′, specific behavior model 1122′, and specific voice model 1123′ to execute corresponding actions, such as playing, foraging together, or communicating. Alternatively, in the Step O42 of Adjusting Emotional Expression, the virtual identity 1141 modifies various parameters in its specific 3D appearance model 1121′, specific behavior model 1122′, and specific voice model 1123′ to express corresponding emotions, such as excitement, fear, or happiness.

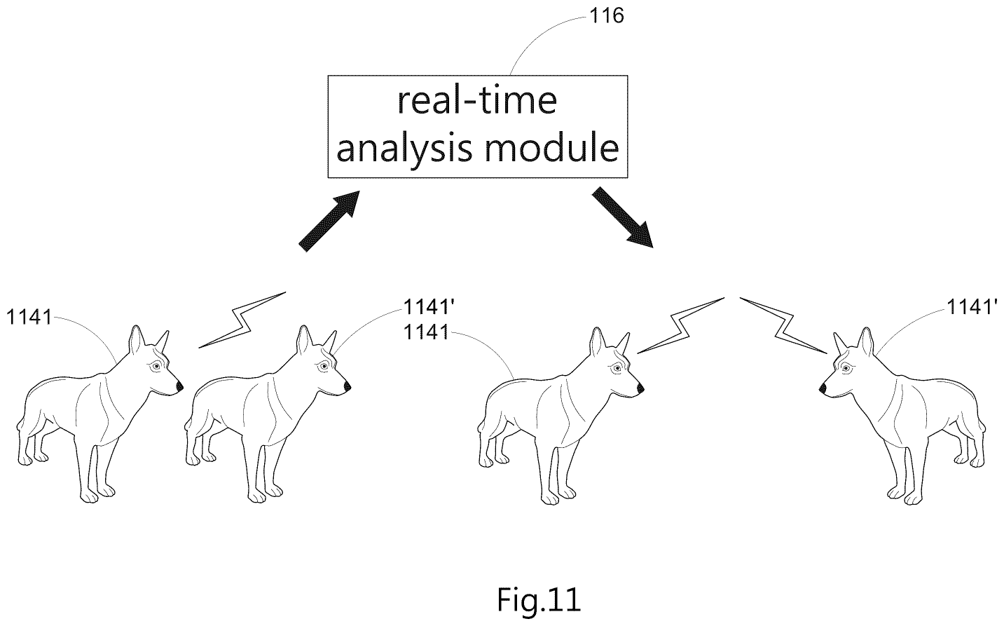

Referring to FIG. 11 in conjunction with FIG. 10, when a specific signal is sent to the virtual identity 1141 by a neighboring virtual identity 1141′, the real-time analysis module 116, through the previously described steps O1 to O42, may trigger a social behavior in the virtual identity 1141 and cause it to respond accordingly.

From the above, it is evident that the present invention, once implemented, can indeed achieve the objective of providing a pet reconstruction system and a method for reconstructing a pet in a virtual world. This system is based on a virtual world infrastructure that allows a lifelike virtual pet to reappear before its owner and engage in interactive experiences. It fulfills the user's need for realistic interactions with a customized virtual pet, thereby recreating the emotional connection between the owner and the pet in the virtual environment.

It should be noted that the above descriptions are merely preferred embodiments of the present invention and are not intended to limit the scope of its implementation. Any equivalent modifications and variations made by those skilled in the art without departing from the spirit and scope of the invention shall fall within the scope of the claims of the present invention.

### LABELS IN GRAPHICS

1 pet reconstruction system
11 server
111 model database
112 customization database
113 data processing module
114 virtual pet generation module
115 environment generation module
116 real-time analysis module
1111 3D appearance model
1112 multiple behavior model
1113 multiple voice model
1121 specific appearance feature
1122 specific behavior feature
1123 specific voice feature
1121′ specific 3D appearance model
1122′ specific behavior model
1123′ specific voice model
1141 virtual identity
1141′ other virtual identity
1151 virtual environment
12 Internet
13 terminal device
131 video camera
132 microphone
1311 motion sensing module
14 virtual reality display device

What is claimed is:

1. A pet reconstruction system based on a virtual world infrastructure, wherein the system is built on a virtual world infrastructure and primarily comprises a server and one or more terminal devices, the server comprising:
a model database, in data communication with the server, configured to store multiple 3D appearance models, multiple behavior models, and multiple voice models for various animal species;
a customization database, in data communication with the server, configured to store uploaded specific appearance features, specific behavior features, and specific voice features of a specific animal;
a data processing module, in data communication with the server, configured to analyze the specific appearance features, specific behavior features, and specific voice features of the specific animal to generate a specific 3D appearance model, a specific behavior model, and a specific voice model for the specific animal, and store the generated models in the customization database;
a virtual pet generation module, in data communication with the server, configured to generate a virtual identity for the particular animal based on the specific 3D appearance model, specific behavior model, and specific voice model of the specific animal to complete the reconstruction; and
a real-time analysis module, in data communication with the server, configured to receive at least one user command from the terminal device and cause the virtual identity to execute any one or a combination of the specific 3D appearance model, specific behavior model, and specific voice model according to the user command, thereby adjusting various parameters in the specific 3D appearance model, specific behavior model, and specific voice model to perform a corresponding action.

2. The pet reconstruction system based on a virtual world infrastructure as claimed in claim 1, wherein the terminal device is in data communication with the server via the Internet for downloading the virtual identity, which includes the specific 3D appearance model, specific behavior model, and specific voice model of the specific animal.

3. The pet reconstruction system based on a virtual world infrastructure as claimed in claim 1, wherein the terminal device further comprises:
a video camera for capturing real-time image data from the real world; and
a microphone for capturing real-time audio data from the real world, wherein the video camera includes a motion sensing module for capturing motion data of at least one object within the real-time image data and transmitting the motion data to the server.

4. The pet reconstruction system based on a virtual world infrastructure as claimed in claim 3, wherein the server further comprises an environment generation module for generating a virtual environment and transmitting at least one environmental command to the real-time analysis module.

5. The pet reconstruction system based on a virtual world infrastructure as claimed in claim 4, wherein the real-time analysis module receives the environmental command from the environment generation module and causes the virtual identity to execute any one or a combination of the specific 3D appearance model, specific behavior model, and specific voice model according to the environmental command.

6. The pet reconstruction system based on a virtual world infrastructure as claimed in claim 4, wherein the real-time analysis module further enables the virtual identity to send and/or receive at least one virtual animal command from at least one other virtual identity in the virtual environment and causes the virtual identity to execute any one or a combination of the specific 3D appearance model, specific behavior model, and specific voice model according to the virtual animal command.

7. The pet reconstruction system based on a virtual world infrastructure as claimed in claim 4,
wherein each 3D appearance model and specific 3D appearance model respectively include at least one or a combination of the following parameters: breed, gender, age, skin color, fur color, markings, body size, and physical structure;
wherein each behavior model and specific behavior model respectively include at least one or a combination of the following parameters: sleeping, foraging, communicating, entertaining, learning, attacking, and defending; and
wherein each voice model and specific voice model respectively include at least one or a combination of the following parameters: pitch, frequency, volume, rhythm, continuity, and voice type.

8. The pet reconstruction system based on a virtual world infrastructure as claimed in claim 7, wherein the real-time analysis module further adjusts the parameters in the specific 3D appearance model, specific behavior model, and specific voice model according to the environmental command.

9. The pet reconstruction system based on a virtual world infrastructure as claimed in claim 7, wherein the real-time analysis module further adjusts the parameters in the specific 3D appearance model, specific behavior model, and specific voice model based on the real-time image data transmitted from the video camera, real-time audio data transmitted from the microphone, and/or motion data transmitted from the motion sensing module to the server.

10. A method for implementing a pet reconstruction system based on a virtual world infrastructure, comprising:
a data upload step, in which specific appearance features, specific behavior features, and specific voice features of a specific animal are uploaded to a customization database of a server;
a model construction step, in which a data processing module of the server analyzes the specific appearance features, specific behavior features, and specific voice features of the specific animal to generate a specific 3D appearance model, a specific behavior model, and a specific voice model for the specific animal, and stores the generated models in the customization database;
a virtual pet generation step, in which a virtual pet generation module of the server generates a virtual identity for the specific animal based on the specific 3D appearance model, specific behavior model, and specific voice model;
an environment generation step, in which an environment generation module of the server generates a virtual environment; and
an interaction step, in which a real-time analysis module of the server receives at least one user command from one or more terminal devices in data communication with the server and/or at least one environmental command from the environment generation module, causing the virtual identity to execute any one or a combination of the specific 3D appearance model, specific behavior model, and specific voice model according to the user command and/or the environmental command.

11. The method for implementing a pet reconstruction system based on a virtual world infrastructure as claimed in claim 10, wherein the terminal device further comprises a video camera for capturing real-time image data from the real world; a microphone for capturing real-time audio data from the real world; and the video camera may include a motion sensing module for capturing motion data of at least one object within the real-time image data and transmitting the motion data to the server.

12. The method for implementing a pet reconstruction system based on a virtual world infrastructure as claimed in claim 11, wherein the terminal device further comprises a video camera for capturing real-time image data from the real world; a microphone for capturing real-time audio data from the real world; and the video camera may include a motion sensing module for capturing motion data of at least one object within the real-time image data and transmitting the motion data to the server.

13. The method for implementing a pet reconstruction system based on a virtual world infrastructure as claimed in claim 12, wherein the model optimization step uses a generative adversarial network (GAN).

14. The method for implementing a pet reconstruction system based on a virtual world infrastructure as claimed in claim 12, wherein each 3D appearance model and specific 3D appearance model respectively include at least one or a combination of the following parameters: breed, gender, age, skin color, fur color, markings, body size, and physical structure; each behavior model and specific behavior model respectively include at least one or a combination of the following parameters: sleeping, foraging, communicating, entertaining, learning, attacking, and defending; and each voice model and specific voice model respectively include at least one or a combination of the following parameters: pitch, frequency, volume, rhythm, continuity, and voice type.

15. The method for implementing a pet reconstruction system based on a virtual world infrastructure as claimed in claim 14, wherein the interaction step further includes a real-time analysis step, in which the real-time analysis module adjusts the parameters in the specific 3D appearance model, specific behavior model, and specific voice model based on real-time image data transmitted from the video camera, real-time audio data transmitted from the microphone, and/or motion data transmitted from the motion sensing module to the server.

16. The method for implementing a pet reconstruction system based on a virtual world infrastructure as claimed in claim 15, wherein the real-time analysis step further comprises:
a step of perceiving user behavior, in which the video camera, the microphone, and/or the motion sensing module detect a movement, a gesture, and/or a voice and transmit the detected data to the server;
a step of collecting user data, in which the real-time analysis module collects real-time user image data, real-time user audio data, and/or user motion data corresponding to the detected movement, gesture, and/or voice;
a step of analyzing user data, in which the real-time analysis module performs an emotional analysis on the collected real-time user image data, real-time user audio data, and/or user motion data;
a step of analyzing user data, in which the real-time analysis module performs an emotional analysis on the collected real-time user image data, real-time user audio data, and/or user motion data;
a step of generating user command, in which the real-time analysis module generates a corresponding user command for the virtual identity based on the emotional analysis results; and
a step of adjusting behavior and/or adjusting emotional expression, in which the virtual identity adjusts various parameters in the specific 3D appearance model, specific behavior model, and specific voice model after receiving the user command based on the emotional analysis results.

17. The method for implementing a pet reconstruction system based on a virtual world infrastructure as claimed in claim 15, wherein the real-time analysis step further comprises:
a step of collecting environmental data, in which, in which the real-time analysis module collects environmental change data from the virtual environment;
a step of analyzing environmental data, in which the real-time analysis module performs an environmental analysis on the collected environmental change data;
a step of generating an environmental command, in which the real-time analysis module generates a corresponding environmental command for the virtual identity based on the results of the environmental analysis; and
a step of adjusting behavior and/or expressing emotions, in which the virtual identity adjusts various parameters in the specific 3D appearance model, specific behavior model, and specific voice model after receiving the environmental command based on the results of the environmental analysis.

18. The method for implementing a pet reconstruction system based on a virtual world infrastructure as claimed in claim 15, wherein the real-time analysis step further comprises:
a step of collecting virtual animal data, in which the real-time analysis module collects behavioral and emotional data of at least one other virtual identity within the virtual environment;
a step of analyzing virtual animal data, in which the real-time analysis module performs a virtual animal analysis on the collected behavioral and emotional data of the other virtual identity;
a step of generating a virtual animal command, in which the real-time analysis module generates a corresponding virtual animal command for the virtual identity based on the results of the virtual animal analysis; and
a step of adjusting behavior and/or a step of adjusting emotional expression, in which the virtual identity modifies various parameters in the specific 3D appearance model, specific behavior model, and specific voice model after receiving the virtual animal command based on the results of the virtual animal analysis.
